(19) United States
(12) Patent Application Publication
(10) Pub. No.: US 2003/0052883 A1
(43) Pub. Date: Mar. 20, 2003

(54) Gradient vector flow fast geodesic active contour

(76) Inventors: Nikolaos Paragyios, Plainsboro, NJ (US); Olivier Mellina-Gottardo, Palaiseau (FR); Visvanathan Ramesh, Plainsboro, NJ (US)

Correspondence Address: Siemens Corporation, Intellectual Property Department, 186 Wood Avenue South, Iselin, NJ, 08830, US

(21) Appl. No.: 10/150,585

(22) Filed: May 17, 2002

Related U.S. Application Data
(60) Provisional application No. 60/292,445, filed on May 17, 2001.

(51) Int. Cl. G06T 11/20

(52) U.S. Cl. 345/442

(57) ABSTRACT

A boundary extraction system comprises a regularity constraint module for, shrinking a curve towards a boundary of one or more objects, a bi-directional curve module for moving the curve towards the object boundaries, and an adaptive balloon force module.

This application claims the benefit of U.S. Provisional Application No. 60/292,445, filed May 17, 2001, which is incorporated by reference herein in its entirety.

### BACKGROUND OF THE INVENTION

1. Field of the Invention

The present invention relates to computer vision, and more particularly to, a method of front propagation flow for boundary extraction, image segmentation and visual grouping.

2. Discussion of Related Art

During the last twenty years, a wide variety of mathematical and computational frameworks have been proposed to deal with computer vision problems. These frameworks are typically based on the fact that many computer vision applications can be viewed as frame partition problems.

The curve propagation approaches, including snake models, were developed based on the work by Kass, Witkin and Terzopoulos in 1987. The snake model corresponds to an elastic curve that is propagated by image forces towards a minimum of an energy generated by an image. Furthermore, the snake model introduces some internal smoothness constraints, which ensure the regularity of the curve. Inspired by the snake model, the snake-balloon model, the Deformable Template Model and the Geodesic Active Contour were successfully derived as geometric alternatives to the snake model.

Numerous methods have been proposed to improve the robustness and stability of the snake model. A “balloon force” has been proposed for introduction into the snake model. The balloon force is an anisotropic pressure potential that controls the evolution of an area enclosed by the model and can either inflate or deflate the contour. A finite elements-based Deformable Template Model has been proposed, which incorporates prior model information. This information can be either general such as regularity constraints or specific such as an exact template.

The snake-based approaches provide a powerful interactive tool to deal with computer vision problems. However, they are “myopic” because of the use of strictly local information and sensitive to the initialization step; if a snake-based model is initialized too far away from the feature of interest it may fail to locate the appropriate energy minimum and provide optimal results. A limitation of the snake-based approaches is the one direction propagation that is imposed by the boundary attraction term. That is, the initial curve is either exclusively shrunk or exclusively expanded towards the object boundaries. Additionally, a snake-based model can be strongly dependent on the parameterization of the curve. Moreover, due to the fact that snake-based models are typically implemented using the Lagrangian approach, they cannot deal naturally with changes of topology. Therefore, only one object can be detected, an important limitation of the snake-based methods. In addition, the snake performance relies on the selection of the parameters that determines the contributions of the different energy terms.

The geodesic active contour model, introduced as a geometric alternative for snakes, can be viewed as an extension of classic snakes since it overcomes the limitations of the snake. The geodesic active contour model can be favorably compared with the classical snake because it does not depend from the curve parameterization and is relatively free from the initial conditions. This model relies to a non-parameterized curve, and evolves an initial curve according to the boundary attraction term towards one direction (inwards or outwards). Thus, to be properly used, it demands a specific initialization step, where the initial curve should be completely exterior or interior to the real object boundaries.

Many efforts have been made to overcome these shortcomings by introducing some region-based features, which make the model free from the initial conditions and more robust. Although these approaches seem to have a reasonable behavior, they still suffer from the one direction flow imposed by the boundary term.

Therefore, a need exists for a system and method for front propagation flow for image segmentation and grouping that makes use of boundary information is independent of initial conditions.

### SUMMARY OF THE INVENTION

According to an embodiment of the present invention, a method for front propagation flow for boundary extraction comprises imposing a regularity constraint on a propagation, shrinking a curve towards object boundaries, moving the curve towards the object boundaries according to a bi-directional flow, and applying an adaptive balloon force.

The bidirectional flow is free from initial curve conditions.

The method extracts boundaries for at least two objects simultaneously.

Applying the adaptive balloon force further comprises determining whether a gradient vector flow is substantially identical to an inward normal. Applying the adaptive balloon force further comprises determining whether the bi-directional flow of the propagation can move the curve given a current state of the curve.

Moving the curve and applying the adaptive balloon force comprise a boundary attraction term. The regularity constraint and the boundary attraction term are mutually exclusive.

According to an embodiment of the present invention, a boundary extraction system comprises a regularity constraint module for, shrinking a curve towards a boundary of one or more objects, a bi-directional curve module for moving the curve towards the object boundaries and an adaptive balloon force module.

The bidirectional flow is free from initial curve conditions.

Boundaries for two or more objects are extracted simultaneously.

The adaptive balloon force module determines whether a gradient vector flow is substantially identical to an inward normal. The adaptive balloon force module determines whether the bi-directional flow of the propagation can move the curve given a current state of the curve.

The bi-directional curve module and the adaptive balloon force module comprise a boundary attraction module. The regularity constraint module and the boundary attraction module are mutually exclusive.

According to an embodiment of the present invention, a program storage device is provided, readable by machine, tangibly embodying a program of instructions executable by the machine to perform method steps for front propagation flow for boundary extraction. The method steps comprise imposing a regularity constraint on a propagation, shrinking a curve towards object boundaries, moving the curve towards the object boundaries according to a bi-directional flow, and applying an adaptive balloon force.

### BRIEF DESCRIPTION OF THE DRAWINGS

Preferred embodiments of the present invention will be described below in more detail, with reference to the accompanying drawings:

FIG. 1 is a view of an input image;

FIG. 2a is an illustrative example of boundary extraction according to a Geodesic Active Contour;

FIG. 2b is an illustrative example of boundary extraction according to a Gradient Vector Flow Snake;

FIG. 2c is an illustrative example of boundary extraction according to an embodiment of the present invention;

FIG. 3 is a diagram of a system according to an embodiment of the present invention; and

FIG. 4 is a flow chart of a method according to an embodiment of the present invention.

### DETAILED DESCRIPTION OF PREFERRED EMBODIMENTS

According to an embodiment of the present invention, a bi-directional, boundary-driven, geometric flow for boundary extraction can be based on visual information according to a gradient vector flow field that refers to a diffusion of a gradient boundary space. This diffusion leads to an external force that drives the propagated curves to an object's boundaries from either side. This force can be implemented as an improvement to the geodesic active contour model, resulting in a bi-directional geometric flow. Furthermore, the implementation of this flow can be done using level set methods where topological changes are handled naturally. To deal with the computational complexity induced by the level set methods, an additive operator splitting (AOS) scheme can be employed that leads to a fast [“real-time”] gradient flow geodesic active contour model.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM) and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

The flow of the present invention compares favorably with the geodesic active contour model because the present invention is substantially free from the initial conditions. Similarly, the present invention compares favorably to the gradient vector flow because the present invention can deal naturally with topological changes. Moreover, a fast numerical method can be used for its implementation.

According to an embodiment of the present invention, a Gradient Vector Flow (GVF) framework comprises a bi-directional external force field that captures the object boundaries from either side, and can deal with concave regions.

A method according to an embodiment of the present invention determines a continuous edge-based information space, which can be given by a Gaussian edge detector (zero mean, with a σ_{E} variance),

$$g ( p ) = \frac{1}{2 π \sqrt{σ E}} {ⅇ}^{- \frac{{\vert ∇ ( {G}_{σ} = I ) ( P ) \vert}^{2}}{2 {σ}_{E2}}} , f ( x , y ) = 1 - g ( p )$$

where G_{σ}*I denotes the convolution of the input image with a Gaussian Kernel (smoothing).

The GVF comprises a two-dimensional vector field [v(p)=(u(p), v(p)), p=(x, y)] that minimizes the following energy

E(ν)=∫∫μ(νₓ²+ν_{y}²+νₓ²+ν_{y}²)+|∇ƒ|²|ν−∇ƒ|²dxdy

where μ is a blending parameter. According to this objective function, areas where the information is constant [|∇f|→0] are dominated by the partial derivatives of the vector field, resulting on a smooth flow map. On the other hand, when there are variations on the boundary space [|∇ƒ| is large], the term that dominates the energy is |∇ƒ|²|ν−∇ƒ|²dxdy, leading to v=∇ƒ.

However, according to the definition of the objective function, the boundary information is not used directly, only its gradient affects the flow. In other words, strong edges as well as weak edges create a similar flow due to the diffusion of the flow information. To overcome this, the objective function can be modified as:

E(ν)=∫∫μ(νₓ²+ν_{y}²+νₓ²+ν_{y}²)+ƒ|∇ƒ|²|ν−∇ƒ|²dxdy

This important modification enables the flow to overcome weak edges due the to presence of noise. In addition, it leads to a fair diffusion of the boundary information where strong edges overcome/compensate flows produced by weak edges.

The minimization of this function can be easily done using the calculus of variations and the following partial differential equation (PDE) can be obtained

$$\frac{ⅆ v}{ⅆ t} ( p ) = μ {∇}^{2} v ( p ) - f ( p ) ( v ( p ) - ∇ f ( x , y ) ) {\vert ∇ f ( p ) \vert}^{2}$$

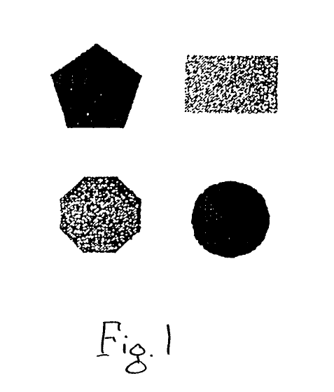

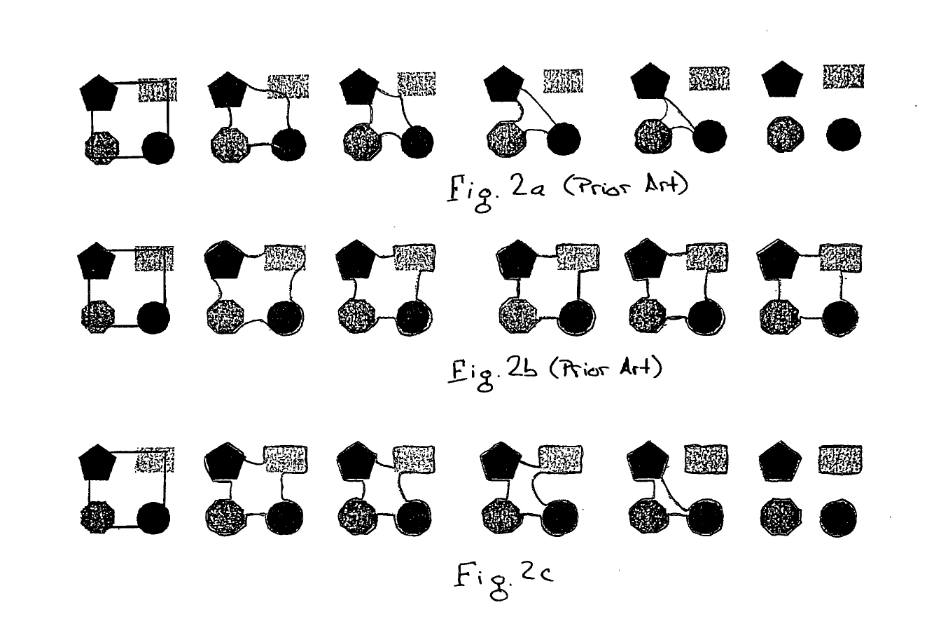

The rescaling of the GVF field [\hat{ν}(p)] leads to a new external force for the boundary term. The GVF field can be rescaled according to its maximum value with an image plane. As shown in FIG. 1, this field comprises contextual information.

The modified GVF field (after the re-scaling) refers to the direction that has to be followed to reach the object boundaries. Thus, given the latest position of the curve, an “appropriate” way to reach these boundaries (from contextual point of view) is to move along the direction of the GVF. Given the fact that level set propagation takes place in the normal direction, the solution can be obtained when the GVF and the unit inward normal are substantially identical. When the GVF is tangential to the normal, no propagation is to be performed. Thus, the best way to determine a contextual and metric propagation given the modified GVF and the unit normal is by the inner product as follows:

Cₜ=(\hat{ν}·N)N

When the GVF and the inward normal have the same direction, then the flow inflates maximally the curve. On the other hand, when these vectors have opposite directions, the flow maximally deflates the curve. When the GVF is tangent to the normal, then no propagation takes place. However, this motion equation, due to the way that the GVF has been estimated and rescaled, does not account for boundary information. Such information can be introduced to the defined flow as:

Cₜ=g(\hat{ν}·N)N

The above flow behaves as follows: in the absence of boundary information, propagation is driven by the contextual information. On the other hand, a combination between the contextual information and the strength of the observed edges can be used to determine the propagation close to the boundaries. This flow does not impose a regularity constraint in the propagation. This is can be addressed by:

Cₜ=βgKN+(1−β)g(\hat{ν}·N)N [Flow 1]

where β is a blending parameter between regularity and boundary attraction terms. This flow, under a constrained scenario, can produce an evolution similar to one obtained by geodesic active contour model. For example, if the term [\hat{ν}·N] that induces the bi-directionality of the flow is ignored, then flow is comparable to the first term (flow) of the geodesic active contour flow. At the same time, when the propagating curve is located close to the object boundaries, then the flow has the same behavior with the second term of the geodesic active contour flow [\hat{ν}·N=∇g·N].

An important limitation of the flow refers to the fact that no propagation is performed when the GVF is tangent (or close to tangent) to the inward normal. This can be dealt with by incorporating an adaptive balloon force. The modified GVF can be used to determine the direction of this new force, which can be combined with the boundary force to define the boundary attraction term:

$${C}_{t} = β gKN + ( 1 - β ) g ( ( 1 - γ ( \hat{v} \cdot N ) ) \underbrace{( \hat{v} \cdot N )}_{attraction} + γ ( \hat{v} \cdot N ) \underbrace{sign ( \hat{v} \cdot N )}_{balloon} ) N \qquad [ Flow 2 ]$$

where γ is a zero-mean Laplacian function, of the inner product, between the normal vector and the rescaled GVF,

$$γ ( \hat{v} \cdot N ) = \frac{λ}{2} {ⅇ}^{- λ \vert \hat{v} \cdot N \vert}$$

The first force imposes a regularity constraint on the propagation and aims at shrinking the curve towards the object boundaries; the second force refers to a sophisticate boundary attraction term that is decomposed in two sub-terms. The first term is a bidirectional flow that moves the curve towards the objects boundaries from both sides. The second sub-force acts as an adaptive balloon force [sign(\hat{ν}·N)] and is activated when the boundary attraction force does not provide enough information to move the curve, e.g., the GVF is tangent to the normal [\hat{ν}·N→0]. These two terms are mutually exclusive (γ( ) function).

The method can be implemented using a Lagrangian approach, which induces several problems. Thus, it cannot deal with topological changes of the moving front and can suffer from instability in the domain of numerical approximations. This can be avoided by representing the moving front ∂R(t) as the zero-level set {Φ=0} of a function Φ. This representation of ∂R(t) is implicit, parameter-free and intrinsic. Additionally, it is topology free. Thus, if the embedding function Φ deforms according to:

Φₜ(p,t)=ƒ(p)|∇Φ(p,t)|

then the corresponding front evolves according to:

Cₜ(p,t)=ƒ(p)N(p)

under the condition:

[Φ(C(p,0),0)=0]

Thus, the evolution of the proposed flows is equivalent to searching for a steady-state solution of the following equations:

Φₜ=βgK|∇Φ|−(1−β)g(\hat{ν}·∇Φ) Flow1:

Φₜ=βgK|∇Φ|− Flow2:

$$( 1 - β ) g ( ) ( ( 1 - γ ( \hat{v} \cdot \frac{∇ Φ}{\vert ∇ Φ \vert} ) ) ( \hat{v} \cdot ∇ Φ ) + γ ( \hat{v} \cdot \frac{∇ Φ}{\vert ∇ Φ \vert} ) sign ( \hat{v} \cdot \frac{∇ Φ}{\vert ∇ Φ \vert} ) \vert ∇ Φ \vert )$$

The main limitation for the use of partial differential equations (and level set methods) in computer vision is poor efficiency because classic numerical approximations are relatively unstable, resulting in time consuming methods. This is due to the need for a stable evolution and convergence to the PDES. A way to overcome this limitation was proposed by Weischert et al., wherein an AOS scheme. Weichert's method can be efficiently used to provide a stable numerical method to a wide variety of PDEs (when the necessary conditions are fulfilled). In order to better introduce the AOS, we will consider the one dimension case. Considering a diffusion equation of the following form:

∂ₜu=div(g(|∇u|)∇u)

then, this diffusion equation can be discretized as follows:

∂ₜu=∂ₓ(g(|∂ᵤ|)∂ₓu)

which leads to the following iterative scheme

u^{m+1}=[I+τA(u^{m})]u^{m}

wherein I is the identity matrix and T is the time step. Although this method explicitly updates the u values using their values from the previous iteration, it is not stable and constrains the time step by an upper bound. A semi-implicit scheme can be used:

u^{m}=[I−τA(u^{m})]u^{m+1}

that has a stable behavior but can be computationally expensive. The AOS scheme refers to the following modification of the semi-implicit scheme:

u^{m+1}=[I−τA(u^{m})]⁻¹u^{m}

that has desirable properties. The scheme is stable, satisfies the criteria for discrete non-linear diffusion, has low complexity (linear to the number of pixels) and can be extended to higher dimensions.

The AOS scheme can be applied to implement the obtained level set flows. It has a fast convergence rate and a very stable behavior with respect to Flow 1, which fulfills all the needed conditions. On the other hand, the time step has to be significantly decreased for the [Flow(2)] to guarantee stability. This constraint is imposed by the nature of the flow, which does not preserve some of the stability conditions needed by the AOS scheme.

To further decrease the needed computational cost of the level set propagations, the AOS scheme can be efficiently combined with the Narrow Method. This method performs the level set propagation within a limited zone that is located around the latest position of the propagating contours, in the inward and outward direction. Thus, the working area is reduced significantly, resulting in a significant decrease of the computational complexity per iteration. However, this method needs a frequent reinitialization of the level set functions that are performed using the Fast Marching algorithm.

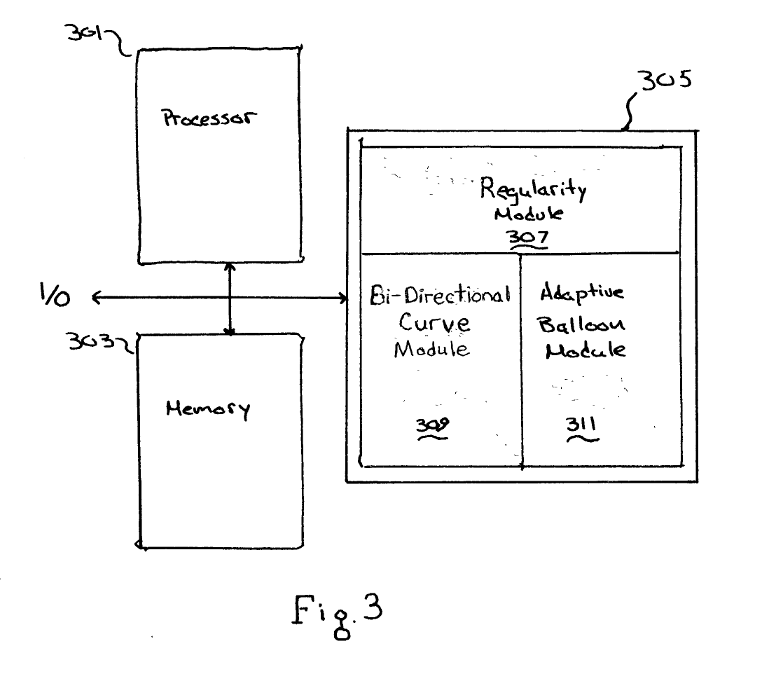

Real images have been used for the validation of the proposed framework. Experimental results are shown in FIGS. 3 to 6. Referring to the computational cost, the average segmentation time for a 200×200 frame using the AOS operator is approximately 1.5 seconds².

Referring to FIG. 3, showing a geometric boundary extraction system, the system includes a processor 301, a memory 303, and a boundary extraction module 305. The boundary extraction module 305 comprises a regularity module 307, a bi-directional curve module 309 and an adaptive balloon module 311 for extracting boundaries for one or more objects in an image.

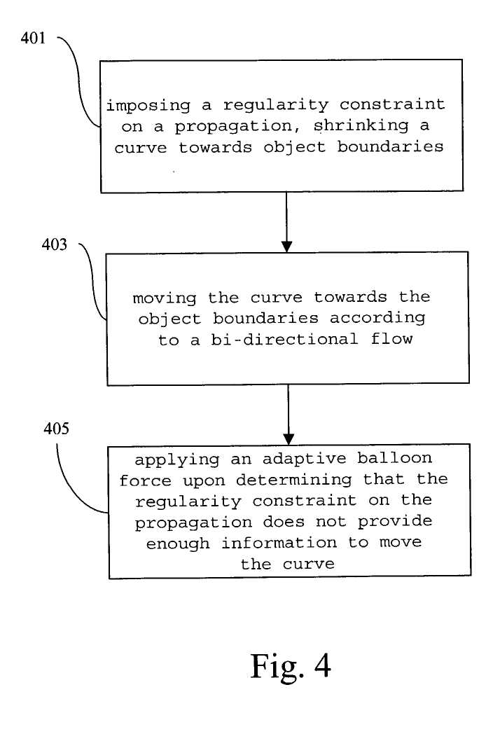

FIG. 4 shows a method for front propagation flow for boundary extraction. The method comprises imposing a regularity constraint on a propagation (shrinking a curve towards object boundaries) 401. The method comprises moving the curve towards the object boundaries according to a bi-directional flow 403, and applying an adaptive balloon force upon determining that the bi-directional flow 403 of the propagation does not provide enough information to move the curve 405.

The boundary information is determined using a modified version of the gradient vector flow, and is incorporated to the geodesic active contour model. This modification leads to a bi-direction flow that is free from the initial curve conditions. A level set implementation of this flow leads to a model that can deal naturally with topological changes, while a recently introduced numerical method is used to guarantee stability and fast convergence rate.

Having described embodiments for a method front propagation flow for boundary extraction, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method for front propagation flow for boundary extraction comprising the steps of:
imposing a regularity constraint on a propagation, shrinking a curve towards object boundaries;
moving the curve towards the object boundaries according to a bi-directional flow; and
applying an adaptive balloon force.

2. The method of claim 1, wherein the bidirectional flow is free from initial curve conditions.

3. The method of claim 1, further comprising the step of extracting boundaries for at least two objects simultaneously.

4. The method of claim 1, wherein the step of applying the adaptive balloon force further comprises determining whether a gradient vector flow is substantially identical to an inward normal.

5. The method of claim 1, wherein the step of applying the adaptive balloon force further comprises determining whether the bi-directional flow of the propagation can move the curve given a current state of the curve.

6. The method of claim 1, wherein the steps of moving the curve and applying the adaptive balloon force comprise a boundary attraction term.

7. The method of claim 6, wherein the regularity constraint and the boundary attraction term are mutually exclusive.

8. A boundary extraction system comprising:
a regularity constraint module for, shrinking a curve towards a boundary of one or more objects;
a bi-directional curve module for moving the curve towards the object boundaries; and
an adaptive balloon force module.

9. The method of claim 8, wherein the bidirectional flow is free from initial curve conditions.

10. The system of claim 8, wherein boundaries for two or more objects are extracted simultaneously.

11. The method of claim 8, wherein the adaptive balloon force module determines whether a gradient vector flow is substantially identical to an inward normal.

12. The method of claim 8, wherein the adaptive balloon force module determines whether the bi-directional flow of the propagation can move the curve given a current state of the curve.

13. The method of claim 8, wherein the bi-directional curve module and the adaptive balloon force module comprise a boundary attraction module.

14. The method of claim 13, wherein the regularity constraint module and the boundary attraction module are mutually exclusive.

15. A program storage device readable by machine, tangibly embodying a program of instructions executable by the machine to perform method steps for front propagation flow for boundary extraction, the method steps comprising:
imposing a regularity constraint on a propagation, shrinking a curve towards object boundaries;
moving the curve towards the object boundaries according to a bi-directional flow; and
applying an adaptive balloon force.
